(19) United States
(12) Patent Application Publication
(10) Pub. No.: US 2022/0169557 A1
(43) Pub. Date: Jun. 2, 2022

(54) ANTIMICROBIAL GLASS

(71) Applicant: CORNING INCORPORATED, CORNING, NY (US)

(72) Inventors: Qiang Fu, Painted Post, NY (US); Yuhui Jin, Painted Post, NY (US); Jackie Lynn Kurzejewski, Covington, PA (US); Santona Pal, Corning, NY (US); Florence Christine Monique Verrier, Corning, NY (US); Lei Yuan, Painted Post, NY (US)

(21) Appl. No.: 17/533,514

(22) Filed: Nov. 23, 2021

Related U.S. Application Data
(60) Provisional application No. 63/119,271, filed on Nov. 30, 2020.

(51) Int. Cl. C03C 3/097; C03C 4/00; C03C 15/00; C03C 19/00; C03C 21/00

(52) U.S. Cl. CPC C03C 3/097; C03C 4/00; C03C 2204/02; C03C 19/00; C03C 21/005; C03C 15/00

(57) ABSTRACT

An antimicrobial glass-based article comprises: a first major surface opposing a second major surface. A first surface region extends 1 micron into the article from the first major surface. The first surface region has an average Ag₂O concentration across the first surface region of equal to or greater than 10 mol % and equal to or less than 30 mol %, and a surface roughness Rₐ of 100 nm or greater.

This application claims the benefit of priority under 35 U.S.C. § 119 of U.S. Provisional Application Ser. No. 63/119,271 filed on Nov. 30, 2020, the content of which is relied upon and incorporated herein by reference in its entirety.

### BACKGROUND

The disclosure relates to glass-based materials having antimicrobial properties. Even more particularly, the disclosure relates to glass-based materials having silver incorporated therein, leading to such antimicrobial properties.

Glass has been widely employed as covers for electronic devices as computer displays, mobile consumer electronics. Many of these devices possess touch functions which require the end users touch (their fingers contact) the device surfaces. The frequency contact of these devices may leave malignant bacteria or virus to the surface. In case of multiple users touch the same device surface, disease may be transmitted through contacting the same device. This is one major concern of using touch devices specially the ones shared in public space such as school, restaurant, and hospital. Even on the personal device, bacteria are accumulated on device surface at very high level.

One way to minimize the stay of bacteria on device surface is to use an antimicrobial cover glass. Antimicrobial cover glass can disinfect bacteria and virus in situ, and keep the population of alive bacteria and virus to a lower level. Antimicrobial glass may contain silver (Ag+) and/or cuprous ions (Cu+) within the glass composition (surface). The release of these ions to glass surface can disinfect bacteria and virus because of the antimicrobial functionalities of silver and copper, such as destroying cell membrane, denaturing protein and enzyme, nicking and damaging DNA and RNA.

But, existing antimicrobial glasses used as cover glass have a relatively mild antimicrobial efficacy compared to what is desired by the market. There is a need for a glass-based article that can pass a US EPA certified antimicrobial “Dry Test”. Such glass will be able to kill minimum 99.9% (3 Log) bacteria in a very short period of time under dry (less humid) environment.

There is a need for a transparent glass-based article suitable for use as a cover glass which passes EPA certified antimicrobial “Dry test” with a 3 Log kill rate.

### SUMMARY

As described herein, transparent glass-based materials with rough surfaces and silver ion-exchanged therein are provided. It is demonstrated that an unexpected synergy between surface roughness and ion-exchanged silver results in anti-microbial efficacy not previously seen for transparent glass-based articles having properties suitable for a cover glass.

In a first aspect, an antimicrobial glass-based article comprises: a first major surface opposing a second major surface. A first surface region extends 1 micron into the article from the first major surface. The first surface region has an average Ag₂O concentration across the first surface region of equal to or greater than 10 mol % and equal to or less than 30 mol %, and a surface roughness Rₐ of 100 nm or greater.

In a second aspect, for the article of the first aspect, the first major surface has a surface roughness Rₐ 300 nm or greater.

In a third aspect, for the article of any preceding claim, the article exhibits a silver ion release rate of equal to or greater than 10,000 ppb/2.25 in² into a neutral pH salt solution at 60° C. over 2 hours.

In a fourth aspect, for the article of any preceding aspect, the article exhibits a silver ion release rate of equal to or greater than 10,000 ppb/2.25 in² and equal to or less than 30,000 ppb/2.25 in².

In a fifth aspect, for the article of any preceding aspect, the article exhibits a log kill equal to or greater than 3 according to the EPA Dry Test with Staph aureus bacteria.

In a sixth aspect, for the article of any preceding aspect, the article exhibits a log kill equal to or greater than 4 according to the EPA Dry Test with Staph aureus bacteria.

In a seventh aspect, for the article of any preceding aspect, the article exhibits a transmittance equal to or greater than 85%.

In an eighth aspect, for the article of any preceding aspect, the article has a color delta E equal to or less than 10 when compared to an otherwise equivalent article without Ag₂O.

In a ninth aspect, for the article of any preceding aspect, the article has a color delta E equal to or less than 7 when compared to an otherwise equivalent article without Ag₂O.

In a tenth aspect, for the article of any preceding aspect, the article has a thickness of 0.2 mm to 3 mm.

In an eleventh aspect, for the article of any preceding aspect, the article is chemically strengthened with an ion in addition to silver.

In a twelfth aspect, for the article of any preceding aspect, the glass-based article has a base composition comprising: from about 50 mol % to about 80 mol % SiO₂; from about 3 mol % to about 25 mol % Al₂O₃; up to about 15 mol % B₂O₃; from about 0 mol % to about 25 mol % Na₂O; up to about 5 mol % K₂O; up to about 35 mol % Li₂O; up to about 5 mol % P₂O₅; up to about 5 mol % MgO; up to about 10 mol % CaO; and up to about 10 mol % ZnO; and wherein 10 mol %≤Li₂O+Na₂O+K₂O≤40 mol %.

In a thirteenth aspect, a process of making a roughened antimicrobial glass-based article is provided. The article has a first major surface opposing a second major surface. The process comprises roughening a glass-based article to create a roughened glass-based article; then exposing the roughened glass-based article to an ion-exchange bath that exchanges silver ions into the roughened glass-based article, to create the roughened antimicrobial glass-based article. a first major surface opposing a second major surface. A first surface region extends 1 micron into the article from the first major surface. The first surface region has an average Ag₂O concentration across the first surface region of equal to or greater than 10 mol % and equal to or less than 30 mol %, and a surface roughness Rₐ of 100 nm or greater.

In a fourteenth aspect, for the article of the thirteenth aspect, the glass-based article is roughened by: exposing the first surface to a laser; then etching the first surface with an etchant.

These and other aspects, advantages, and salient features will become apparent from the following detailed description, the accompanying drawings, and the appended claims.

### BRIEF DESCRIPTION OF THE DRAWINGS

FIG. 1 shows a cross-sectional view of a glass-based material having a rough surface and silver ions disposed therein;

FIG. 2 shows a cross-sectional view of a glass-based material having a rough surface and silver ions disposed therein, with a compressive stress layer.

FIG. 3 is a flowchart illustrating a process for making glass-based articles descried herein.

FIG. 4 shows log kill rates according to the EPA Dry Test for Samples 1 and 2 (GC1) according to Example 1.

FIG. 5 shows log kill rates according to the EPA Dry Test for Samples 3 through 10 (GC1, various textures).

FIG. 6 shows log kill rates according to the EPA Dry Test for Samples 11 through 17 (various materials).

FIG. 7 shows the results of SIMS analysis for Sample 1.

FIG. 8A shows a top view of the textured GC1 surface with Backscatter electron mode (scale bar: 20 um).

FIG. 8B shows a cross-sectional view of the textured surface (Scale 5: 5 um).

FIG. 8C shows a cross-section view of the textured surface at a different scale (Scale bar: 50 um).

FIG. 8D shows a cross-section view with highlighted silver distribution mapped by EDS.

FIG. 9 shows a correlation of EPA dry test Log kill and released silver concentration from the silver ion release rate.

The illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

### DETAILED DESCRIPTION

### Glossary

A—As used herein the terms “the,” “a,” or “an,” mean “one or more,” and should not be limited to “only one” unless explicitly indicated to the contrary. Thus, for example, reference to “a component” includes embodiments having two or more such components unless the context clearly indicates otherwise.

About—As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

Base Composition: As used herein, for a chemically-strengthened or otherwise ion-exchanged article, the “base composition” of the article is the composition prior to ion exchange. The best way to measure the base composition is to obtain a sample prior to ion-exchange and measure composition. Xray fluorescence (XRF) and ion coupled plasma (ICP) are two techniques that may be used to determine composition of a sample that has not been ion exchanged. Unless otherwise specified, ICP is preferred. If only an ion-exchanged article is available, base composition may be measured by looking at the composition in the geometric center of the article, or at another location having a similar location. Ion-exchange generally changes composition near the surface of an article by exchanging one type of ion for another, but does not change composition at the center, so the center of the article most often remains a good indicator of base composition even after ion exchange. Microprobe analysis and Glow Discharge Optical Emission Spectroscopy (GDOES) are two methods that may be used to determine composition in the center of a sample. GDOES is preferred.

Central Tension—central tension (CT) and maximum CT values are measured using a scattered light polariscope (SCALP) techniques known in the art. Refracted near-field (RNF) method or SCALP may be used to measure the stress profile. When the RNF method is utilized, the maximum CT value provided by SCALP is utilized. In particular, the stress profile measured by RNF is force balanced and calibrated to the maximum CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass-based article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal. The RNF profile is then smoothed, and used for the CT region.

Chemically Strengthened—As used herein, a glass-based article is considered chemically strengthened if it has been exposed to an ion exchange process. In this process, ions at or near the surface of the glass-based article are replaced by—or exchanged with—larger ions having the same valence or oxidation state. In those embodiments in which the glass-based article comprises an alkali aluminosilicate glass, ions in the surface layer of the glass and the larger ions are monovalent alkali metal cations, such as Li⁺ (when present in the glass-based article), Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass-based substrate generate a stress in the resulting glass-based article. Chemical strengthening may be detected, for example, by microprobe analysis to determine a profile of composition vs. depth.

Comprising—As used herein, the terms “comprising” and “including,” and variations thereof shall be construed as synonymous and open-ended, unless otherwise indicated.

Compressive Stress—Compressive stress (including surface CS, or CS_{S}) is measured by surface stress meter (FSM) using commercially available instruments such as the FSM-6000, manufactured by Orihara Industrial Co., Ltd. (Japan). Surface CS is the compressive stress at the surface of an article. Surface CS stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

According to some conventions used in the art, compression is expressed as a negative (<0) stress and tension is expressed as a positive (>0) stress, unless specifically noted otherwise. Throughout this description, however, when speaking in terms of compressive stress CS, such is given without regard to positive or negative values—i.e., as recited herein, CS=|CS|.

Delta E—As used herein, Delta E refers to a difference in L*a*b* coordinates, and is a way to quantify color change. The relevant L*a*b* coordinates were measured on a PE X-RITE Color i7-860 using D65 Illuminant. The color change (Delta E) was determined by taking L*a*b* measurements on otherwise similar samples before and after silver ion exchange. Delta E is calculated by comparing the pre- and post-silver IOX using the equation:

$$√ ( {( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2} )$$

where the “2” subscript indicates a post-IOX value, and the “1” subscript indicates a pre-IOX value.

Depth of Compression—As used herein, depth of compression (DOC) means the depth at which the stress in the chemically strengthened alkali aluminosilicate glass article described herein changes from compressive to tensile. DOC may be measured by FSM or a scattered light polariscope (SCALP) depending on the ion exchange treatment. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles is measured by FSM.

DOL—As used herein, the terms “chemical depth”, “chemical depth of layer”, “depth of chemical layer” and “depth of layer (DOL) may be used interchangeably and refer to the depth at which an ion of the metal oxide or alkali metal oxide (e.g., the metal ion or alkali metal ion) diffuses into the glass-based article and the depth at which the concentration of the ion reaches a minimum value, as determined by Electron Probe Micro-Analysis (EPMA) or Glow Discharge-Optical Emission Spectroscopy (GD-OES)).

EPA Dry Test: EPA Dry test refers to a test published by the EPA as “Test Method for Efficacy of Copper Alloy Surfaces as a Sanitizer” that may be used to evaluate antimicrobial efficacy. To the extent there are differences between what is described in the EPA protocol and what is described herein, references to the “Dry Test’ refer to what is described herein. A sample of Staph aureus bacteria is placed on a dry sample surface. The surface is held at room temperature (25° C.) and room humidity (42% relative humidity) for 2 hours. The amount of bacteria surviving is then measured to determine the “log kill rate” due to exposure to the surface for two hours at room temperature and humidity. 10% surviving bacteria is a log kill rate of 1, 1% surviving bacteria is a log kill rate of 2, 0.1% surviving bacteria is a log kill rate of 3, and so on. According to some standards, a log kill rate of 3 or greater passes the EPA Dry Test, whereas lower log kill rates fail the test. Achieving a log kill rate of 3 may allow certain claims on the label of a product in the US.

Glass-Based—As used herein, the terms “glass-based article” and “glass-based substrates” are used in their broadest sense to include any object made wholly or partly of glass. Glass-based articles include laminates of glass and non-glass materials, laminates of glass and crystalline materials, and glass-ceramics (including an amorphous phase and a crystalline phase). Unless otherwise specified, all compositions are expressed in terms of mole percent (mol %).

Integrated Central Tension—As used herein, integrated central tension (ICT) refers to the area of the central tension region of a stress profile across the entire thickness of an ion-exchanged substrate.

Haze: Haze is measured using a Haze-gard Dual Transparency Transmission Haze Meter, according to ASTM D1003 using Illuminant D65.

Gloss 60: Gloss 60 refers to a measurement taken at 60 degrees from vertical using a Rhopoint Glossmeter.

Integrated Compressive Stress—As used herein, integrated compressive stress (ICS) refers to the area of the compressive regions of a stress profile across the entire thickness of an ion exchanged substrate. In general, any compressive stress in an article is balanced by an equal amount of tension elsewhere in the article. As such, absent external forces or localized asymmetry, integrated compressive stress equals integrated central tension across a given stress profile.

Ion Exchange Process—Ion exchange processes are typically carried out by immersing a glass-based substrate in a molten salt bath (or two or more molten salt baths) containing the larger ions to be exchanged with the smaller ions in the glass-based substrate. It should be noted that aqueous salt baths may also be utilized. In addition, the composition of the bath(s) may include more than one type of larger ion (e.g., Na+ and K+) or a single larger ion. It will be appreciated by those skilled in the art that parameters for the ion exchange process, including, but not limited to, bath composition and temperature, immersion time, the number of immersions of the glass-based article in a salt bath (or baths), use of multiple salt baths, additional steps such as annealing, washing, and the like, are generally determined by the composition of the glass-based article (including the structure of the article and any crystalline phases present) and the desired DOC and CS of the glass-based article that results from strengthening. By way of example, ion exchange of glass-based substrates may be achieved by immersion of the glass-based substrates in at least one molten bath containing a salt such as, but not limited to, nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass thickness, bath temperature and glass (or monovalent ion) diffusivity. However, temperatures and immersion times different from those described above may also be used.

Ion-Exchanged Composition: As used herein, for a chemically-strengthened or otherwise ion-exchanged article, the “ion-exchanged composition” of the article is the composition after ion exchange. Because ion exchange is often used to create gradients of various material components within an article, it often makes sense to measure ion-exchanged composition as a function of position near the surface and within the article. Such measurements can be performed by SIMS (secondary ion mass spectroscopy), in which an ion beam is used to sputter a surface at increasing depths, and the ejected secondary ions are analyzed for composition. Unless otherwise specified, SIMS measurements are performed on a Ion-ToF ToF-SIMS M6. Related depth measurements are performed offline using a KLA/Tencor P-17 stylus profilometer.

Mol %: concentrations of materials in glass-based articles are provided in mol % on an oxide basis.

Ranges—Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

Silver Ion Release Rate: as used herein, “silver ion release rate” is measured by an accelerated silver ion leaching test. In this test, a glass-based surface is covered with neutral pH salt solution at certain glass surface to solution volume ratio. The glass-based surface and solution are held at a temperature of 60° C. for 2h, during which time silver ions may be released into the solution. The silver ion concentration in the salt solution is then quantified by ICP-FES. This quantification may then be used to determine how many silver ions were released per unit area of the glass-based surface. While the test should not be affected by the size of the area tested, an area 1.5 by 1.5 inches (2.25 inches squared) within a larger samples were used for the accelerated silver ion leaching test. The accelerated silver ion leaching test is described in more detail in the Experimental section of this document.

Surface Roughness: As used herein, unless otherwise specified, “surface roughness” refers to Rₐ, the arithmetical mean deviation of a measured profile. Unless otherwise specified, Rₐ is measured on a Zygo 7000 with the following settings: Scan size was 180 microns by 220 microns; Objective: 20× Mirau; Image Zoom 2×; Camera resolution 0.2777 microns; Filter: low Pass; Filter Type: Average; Filter Low Wavelength 0; Filter High Wavelength: 0.83169 microns;

Stress Profile—A “stress profile” is stress with respect to position of a glass-based article or any portion thereof. A compressive stress region extends from a first surface to a depth of compression (DOC) of the article, where the article is under compressive stress. A central tension region extends from the DOC to include the region where the article is under tensile stress. The stress profiles described herein were measured via a combination of refractive near field and Orihara FSM-6000 LE for surface stress.

Substantial—The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example within about 5% of each other, or within about 2% of each other.

Transmittance: Transmittance is measured using a Haze-gard Dual Transparency Transmission Haze Meter, according to ASTM D1003 using Illuminant D65.

### Antimicrobial Glass-Based Article with Rough Surface

In some embodiments, a textured glass/glass ceramic article is provided with superior antimicrobial efficacy (99% or 99.9% Log kill in EPA antimicrobial dry test). More specifically, the article possesses textured surface with surface roughness of higher than 300 nm (Rₐ) The article also includes a surface region comprising silver oxide (Ag₂O) at a concentration of 10 mol % or higher.

The article may have a silver ion-releasing rate measured by accelerated leaching test of 10000 ppb/2.25 in² glass surface or higher, or 30000 ppb/2.25 in² glass surface or higher.

The article may be transparent (transmittance equal to or greater than 85%), and may have a color (delta E) compared to non-antimicrobial counterpart less than 10, and transmittance haze of higher than 50%.

In some embodiments, a process for making an antimicrobial textured glass article with superior antimicrobial efficacy is provided. First, a base composition with fast ion-exchange rate (diffusion rate) and high mol % of monovalent metal ions is chosen. The mol % of monovalent cations is higher than 10 mol %, such that at least 10 mol % silver ions can be exchanged into the article. Second, the glass surface is textured through processes such as (1) laser+etch, (2) sandblast+etch, (3) chemical texturing and polishing, to a surface roughness of 300nm (Rₐ) or greater. Third, silver ions are installed to the textured glass surface through molten salt ion-exchange process. Finally, the glass is cleaned.

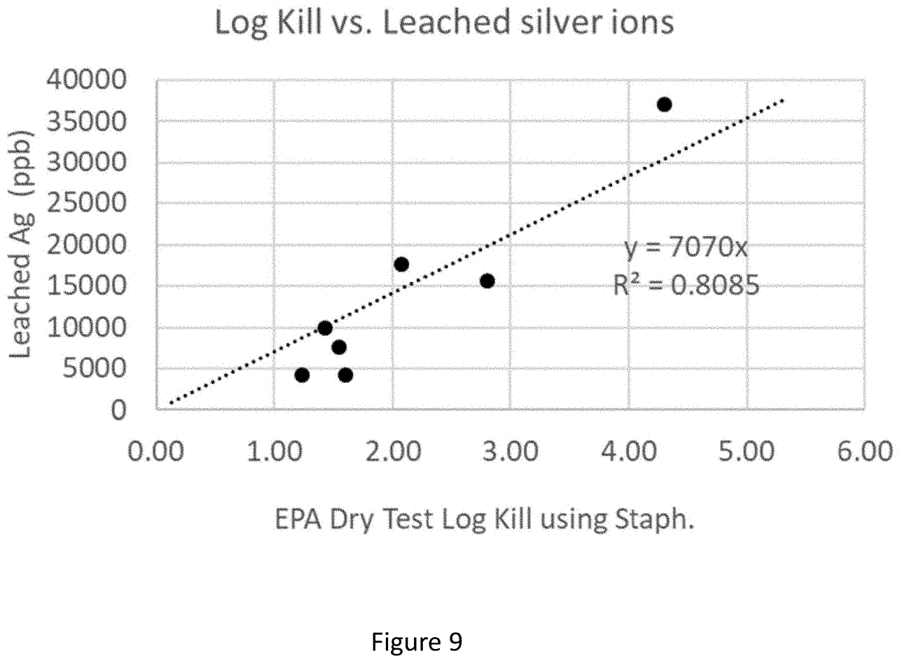

The antimicrobial (AM) capability of a glass can be estimated by using a silver ion release rate test. Samples with higher silver ion release rates usually have higher AM efficacy (high Log Kill), as shown in FIG. 9 (and Table 1).

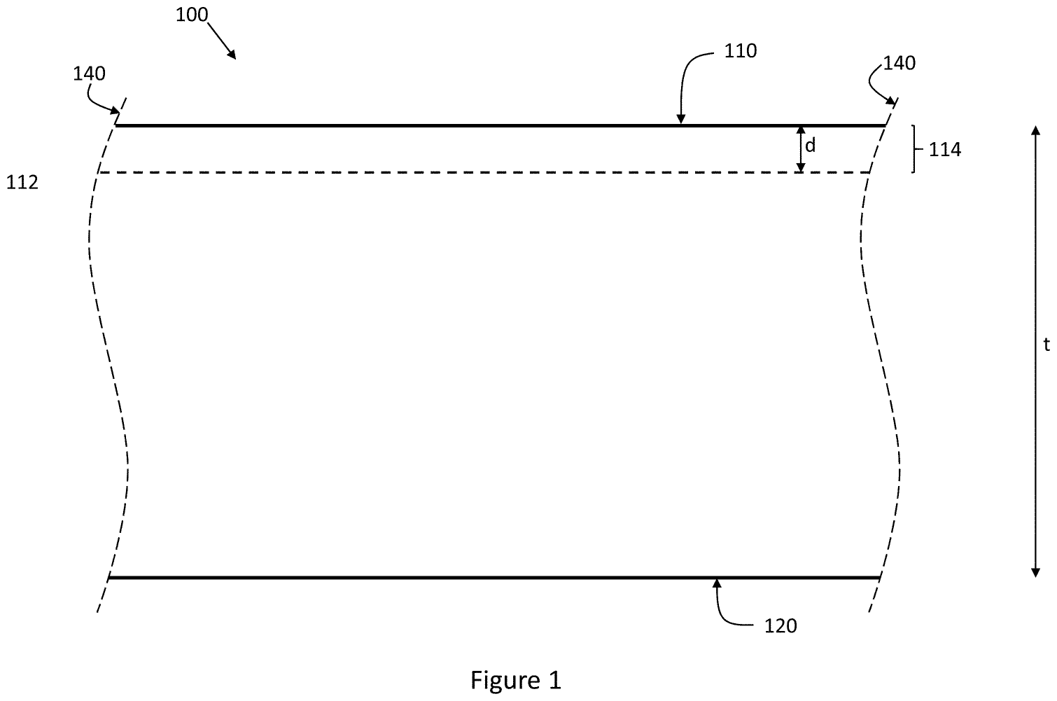

FIG. 1 shows an exemplary cross-sectional side view of a glass-based article 100. Article 100 has a first surface 110 and an opposing second surface 120 separated by a thickness (t). First surface 110 has a high surface roughness, i.e., Rₐ equal to or greater than 300 nm. Second surface 120 may or may not have a high surface roughness. A first surface region 114 extends a depth d from surface 110. First surface region 114 comprises 10 mol % or more Ag₂O. Break lines 140 indicate that only a portion of article 100 is illustrated.

In some embodiments, d is 1 micron. 1 micron is believed to represent the distance into the article where silver ions can move through the material to the surface in a time period relevant to antimicrobial efficacy. Ag may be present deeper into the article, but such Ag may not contribute much to antimicrobial efficacy, and may have undesirable effects such as undesirable color change, or displacement of other ions that could contribute to desired stress profile characteristics.

In some embodiments, t is 0.2 mm to 3 mm. This range of thicknesses is suitable for use as a cover glass or housing for a hand-held electronic device. Different thicknesses, including those outside of this range, may be used depending on desired characteristics.

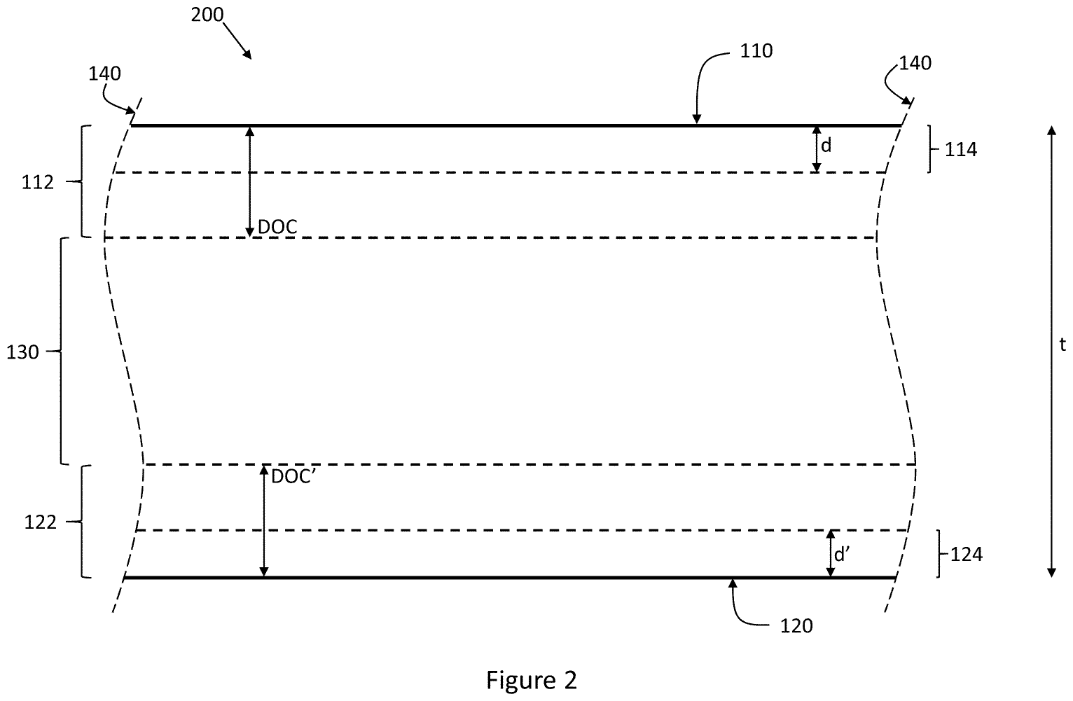

FIG. 2 shows an exemplary cross-sectional view of a glass-based article 200. FIG. 2 and article 200 show optional features that may be added to article 100 of FIG. 1. Similar to article 100, article 200 includes first surface 110, opposing surface 120 and first surface region 114 as described with respect to FIG. 1. In article 200, second surface 120 also has a high surface roughness, i.e., Rₐ equal to or greater than 40 nm. Article 200 further shows a second surface region 124 that extends a depth d′ from second surface 120. Second surface region 124 comprises 10 mol % or more Ag₂O. In embodiments, glass-ceramic article 100 has been ion-exchanged with a material in addition to silver, and has a compressive stress (CS) layer 112 extending from first surface 110 to a first depth of compression DOC, and a CS layer 122 extending from second surface 120 to a second depth of compression DOC′. There is also a central tension region 130 under tensile stress in between DOC and DOC′.

Article 100 (and 200) can adopt a variety of physical forms. That is, from a cross-sectional perspective, article 100 may be flat or planar as illustrated, or curved and/or sharply-bent. Similarly, it can be a single unitary object, or attached to something else to form a multi-layered structure or a laminate. Surface Roughness

First surface 110 (and optionally second surface 120) has a high surface roughness, i.e., Rₐ equal to or greater than 300 nm. This surface roughness, combined with the silver content of first surface region 114 (and optionally second surface region 124) leads to exceptional log kill rates under dry test conditions such as the EPA dry test.

Without being limited to any theory as to why the high kill rate is observed, it is believed that several factors may contribute. First, a rough surface has a higher specific surface area per unit area than a smooth surface. In other words, the peaks, valleys, bumps, sloped surfaces and the like associated with roughness result in an increased area of exposed interface between solid and air when compared to a smooth surface. This higher specific surface area may lead to a higher rate of silver release or leach from the solid, because there is a more exposed interface across which silver may be released. This first point is consistent with by silver ion release rate data herein showing higher silver release rates for rougher surfaces. Second, there may be a synergy between the presence of silver and roughness for microbe-killing efficacy. For example, the rough surface may enable faster silver penetration into the microbe. Third, the high roughness may retain silver that has leached from the article better than a smoother surface.

In some embodiments, first surface 110 (and optionally second surface 120) has a surface roughness Rₐ equal to or greater than 100 nm, 200 nm, 300 nm, 400 nm, 500 nm, 600 nm or 700 nm. R_{a may be} 300 nm, 400 nm, 500 nm, 600 nm, 700 nm, 800 nm, 900 nm, 1000 nm, 1500 nm, 2000 nm, 3000 nm or 4000 nm, or any range having any two of these values as endpoints. In some embodiments, R_{a is} 200 nm to 4000 nm, 300 nm to 2000 nm, 500 nm to 1000 nm or 700 nm to 1000 nm. At values lower than these, the surprisingly enhanced antimicrobial activity observed herein may not be present. Higher values may be used, but it is exceeding expensive to manufacture glass based surfaces with higher surface roughness, and mechanical durability may be reduced.

A surface roughness of 100 nm or 300 nm is unusually high for a glass-based article used as a cover glass, unless special efforts have been made to achieve such roughness. For many glass-based compositions used as cover glass, typical finishing processes will not achieve this type of surface roughness of 300 nm or higher. The present disclosure describes the use of a special technique involving laser damage followed by etch to achieve the desired surface roughness. Sandblast and etch is another suitable technique, as is chemical etching where the process is specifically tailored to achieve the desired surface roughness.

TABLE 1
Process information and data of samples

| | | | | EPA Dry | | | | | |
|---|---|---|---|---|---|---|---|---|---|
| | | | EPA Dry | Test Log | Silver | | | | |
| | | | Test Log | Kill | Ion | | | | |
| Sam- | | | Kill | standard | Release | | | | |
| ple | | Roughening | average | deviation | Rate | | | | Delta |
| # | Material | Treatment | (staph) | (staph) | Test* | L* | a* | b* | E2000 |
| 1 | GC1 | Laser and | 4.54 | 0.00 | | | | | |
| | | etch | | | | | | | |
| 2 | GC1 | Laser and | 4.31 | 0.34 | | | | | |
| | | etch | | | | | | | |
| 3 | GC1 | none | 2.81 | 0.04 | | | | | |
| 4 | GC1 | none | 1.74 | 0.07 | | | | | |
| 5 | GC1 | none | 1.64 | 0.09 | | | | | |
| 6 | GC1 | none | 2.43 | 0.18 | | | | | |
| 7 | GC1 | none | 1.24 | 0.02 | | | | | |
| 8 | GC1 | Laser and | 5.16 | 0.00 | | | | | |
| | | etch | | | | | | | |
| 9 | GC1 | Laser and | 4.38 | 0.10 | | | | | |
| | | etch | | | | | | | |
| 10 | GC1 | Laser and | 1.96 | 0.03 | | | | | |
| | | etch | | | | | | | |
| 11 | G-1 | Laser, no | 2.08 | 0.07 | 17650 | 92.39 | 0.33 | 3.62 | 3.43 |
| | | etch | | | | | | | |
| 12 | G-1 | none | 1.13 | 0.04 | | 96.08 | 0.12 | 1.14 | 0.98 |
| 13 | GC2 | none | 1.61 | 0.13 | 4220 | 96.22 | −0.06 | 1.34 | 1.18 |
| 14 | GC2- | none | 1.43 | 0.03 | 9880 | 94.94 | −0.46 | 4.89 | 4.26 |
| | precursor | | | | | | | | |
| 15 | GC3 | none | 1.54 | 0.01 | 7610 | | | | |
| 16 | GC4- | none | 1.44 | 0.16 | | 93.74 | 0.28 | 5.58 | 4.84 |
| | precursor | | | | | | | | |
| 17 | GC4- | none | 1.49 | 0.02 | | | | | |
| | ceramic | | | | | | | | |
| | (white | | | | | | | | |
| | ceramic) | | | | | | | | |
| 18 | GC1; #2 | Laser and | 4.31 | 0.34 | 37000 | | | | |
| | similar | etch | | | | | | | |
| 19 | GC1; #7 | none | 1.24 | 0.02 | 4270 | 88.68 | 0.46 | 8.58 | 6.73 |
| | similar | | | | | | | | |
| 20 | GC1; #3 | none | 2.81 | 0.04 | 15560 | 95.67 | −0.06 | 2.30 | 2.08 |
| | similar | | | | | | | | |

*units for Silver Ion Release Rate test are ppb/2.25 in² released into a neutral pH salt solution at 60° C. over 2 hours.

In table 1, “laser” means the sample was laser treated as described in more detail in Examples 1 and 2. “etch” means the sample was exposed to 50 wt % NaOH for 3 hours at 132° C.

Each of Samples 1 through 20 were subject to silver ion exchange. Silver ion exchange was performed after the roughening treatment, if any. Silver ion exchange for all samples was performed in a molten solution of 47.5 wt % KNO₃, 47.5 wt % NaNO₃, and 5 wt % AgNO₃. The ion exchange conditions for ion exchange of silver were:
Samples 1 and 2: 390° C. for 1 hr.
Samples 3 through 10: 390° C. for 10 mins.
Samples 11 through 20: 350° C. for 10 mins.

Haze, transmittance, Gloss 60, Rₐ and R_{q} were measured for Samples 1, 2 and 10. These samples were all treated with a laser then etched. Measurements were performed on the samples after laser treatment and before etch, and also after laser treatment and after NaOH etch. The results are shown in Table 2.

TABLE 2
Laser textured sample information.

| | | | | Trans- | | | |
|---|---|---|---|---|---|---|---|
| | | | | mit- | | Ra | Rq |
| Sample | Information | Haze | | tance | Gloss 60 | (nm) | (nm) |
| #1 | After laser, | 64 | (high) | 66.9 | 31.3 | 158 | 300 |
| | before etch | | | | | | |
| #1 | After laser | 54.3 | (high) | 87.8 | 9.9 | 759 | 1233 |
| | and etch | | | | | | |
| #2 | After laser, | 77.5 | (high) | 43.3 | 57.9 | 100 | 190 |
| | before etch | | | | | | |
| #2 | After laser | 59.3 | (high) | 60.5 | 32 | 346 | 715 |
| | and etch | | | | | | |
| #10 | After laser, | 8.22 | (low) | 88 | 64.3 | 48 | 88.5 |
| | before etch | | | | | | |
| #10 | After laser | 48.2 | (low) | 89.2 | 18.1 | x | x |
| | and etch | | | | | | |

### First Surface Region

In some embodiments, silver ions are provided at the surface of a glass-based article to disinfect bacteria or virus. In a typical process, silver ions are installed into glass surface layer by dipping glass article (with alkali metal ions) in molten nitrate salt containing silver ions. The ion exchange reaction generates antimicrobial (AM) glass with silver ions in at least the first micron. The release of the silver ions from glass kills bacteria cells or virus on the surface.

First surface region 114 (and optionally second surface region 124) comprise Ag₂O at a concentration of 10 mol % or higher.

It is preferred that Ag₂O is introduced into article 100 by ion exchange, such that much of the silver in article 100 is located in first surface region 114, and the concentration of Ag₂O in the bulk material is significantly lower or zero (allowing for impurities). In other words, it is preferred that the bulk composition has a low silver concentration, for example equal to or less than 1 mol % or 0.1 mol %. This is because anti-microbial efficacy is a surface effect, and silver farther than 1 micron (1000 nm) away from surface 110 is not expected to contribute significantly to antimicrobial efficacy. But, silver also has optical effects such as discoloration that may be considered undesirable, whether the silver is in the bulk material or concentrated in surface region 114. Minimizing the amount of silver in article 100 beyond that in first surface region 114 minimizes these undesirable optical effects without losing antimicrobial efficacy.

The concentration of Ag₂O in first surface region 114 (and optionally second surface region 124) is equal to or greater than 10 mol %. The Ag₂O concentration may be 10 mol %, 15 mol %, 20 mol %, 25 mol % or 30 mol %, or any range having any two of these values as endpoints. In some embodiments, the Ag₂O concentration is 10 mol % to 30 mol %, or 15 mol % to 25 mol %.

It is believed that a combination of high surface roughness and high silver concentration in first region 114 leads to a high silver ion release rate. Such articles described herein may exhibit a silver ion release rate of equal to or greater than 10,000 ppb/2.25 in² and equal to or less than 30,000 ppb/2.25 in^{2.} The silver ion release rate may be 10,000 ppb/2.25 in², 15,000 ppb/2.25 in², 20,000 ppb/2.25 in², 25,000 ppb/2.25 in² or 30,000 ppb/2.25 in², or any range having any two of these values as endpoints.

It is also believed that a combination of high surface roughness and high silver concentration in first region 114 leads to a surprisingly high kill rate under the EPA Dry Test described herein. The articles may exhibit a log kill rate equal to or greater than 3, 3.5, 4, 4.5 or 5. The log kill rate may be 3, 3.5, 4, 4.5 or 5 or any range having any two of these values as endpoints. In some embodiments, the log kill rate is 3 to 5. It should be noted that it is much more difficult to achieve a high log kill rate under the EPA Dry Test than under wet tests often used to evaluate anti-microbial efficacy, because there is limited or no liquid water present under the test conditions of the EPA Dry Test to help antimicrobial ions diffuse out of an article. Accordingly, reports of kill rates under other tests for various samples is not dispositive of whether those samples can pass the EPA Dry Test, and kill rates under the EPA Dry Test are expected to be much lower than they would be under wet tests for many articles.

Second surface 120 and second surface region 124 may include none, some or all of the rough and silver-containing features of first surface 110 and first surface region 114. In many typical cover glass applications, only a single side of the cover glass, for example first surface 110, faces the user. The other side, for example second surface 120, may face the interior of the electronic device, and not have contact with the user. As such, it may not be beneficial from an application standpoint have second surface 120 the same as first surface 110 in terms of roughness, silver content and anti-microbial efficacy. In fact, it may be beneficial that second surface 120 not be roughened and/or not include ion-exchanged limit the optical effects associated with roughness and/or silver content to what is present at first surface 110. Processing is another consideration. When processing chemically, such as exposing an article to an etchant or ion exchange bath, it may often be easier and less expensive to avoid masking during processing, and expose both sides of an article to the same treatment. Conversely, when roughening with a laser, it may easier and less expensive to treat only a single side with the laser.

In some embodiments, delta E is equal to or less than 10, or equal to or less than 7. Delta E is determined by measuring the L*a*b* coordinates before and after silver ion exchange, and determining the difference in color with an appropriate calculation for the square root of the sum of the squares of the three L*a*b* coordinates:

$$√ ( {( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2} )$$

Lower delta E corresponds to a less noticeable color difference. In some embodiments, the surprising antimicrobial effectiveness of silver when combined with a rough surface as described herein allows for exceptional antimicrobial effectiveness while not using so much silver that it changes the appearance of a material too much.

Glass Composition

Generally, embodiments described herein may be practiced with any glass or glass ceramic composition that includes, or is able to include via ion exchange, first surface region 114 with 10 mol % Ag₂O or more. In some embodiments, a glass or glass-ceramic composition is used that initially contains little or no Ag₂O, but that can be ion-exchanged to include first surface region 114 with 10 mol % Ag₂O or more.

Glass-based materials with good AM efficacy should have high silver ion concentration at the surface (within 1 micron of the surface) and capability to release silver ions in a rapid manner (quick ion diffusion rate). To achieve that, the glass-based article should contain high concentration of exchangeable monovalent metal ions (e.g. Li, Na, K) before silver IOX. Table 3 provides examples of such materials. More examples can be found in U.S. Pat. No. 9,840,437, which is incorporated by reference in its entirety.

U.S. Pat. No. 9,840,437 discloses glasses that may be ion exchanged with silver to a concentration of 10 mol % to 30 mol %. In some embodiments, the glass-based article has the composition described in U.S. Pat. No. 9,840,437, broadened to include some of the examples disclosed herein, including glass-ceramic compositions. These base compositions consist essentially of or comprise: at least about 50 mol % SiO₂ (i.e., SiO₂≥50 mol %); from about 3 mol % to about 25 mol % Al₂O₃ (i.e., 3 mol %≤Al₂O₃ 25 mol %); up to about 15 mol % B₂O₃ (i.e., 0 mol %≤B₂O₃ ≤15 mol %); from about 0 mol % to about 25 mol % Na₂O (i.e., 0 mol %≤Na₂O≤25 mol %); up to about 5 mol % K₂O (i.e., 0 mol %≤K₂O≤5 mol %); from 0.0 mol % to about 35 mol % Li₂O (i.e., 0 mol %≤Li₂O≤35 mol %); up to about 5 mol % P₂O₅ (i.e., 0 mol %≤P₂O≤5 mol %); up to about 5 mol % MgO (i.e., 0 mol %≤MgO≤5 mol %); up to about 10 mol % CaO (i.e., 0 mol %≤CaO≤10 mol %); and up to about 10 mol % ZnO (i.e., 0 mol %≤ZnO≤10 mol %), wherein the sum of the alkali metal oxide modifiers is greater than or equal to 5 mol % and less than or equal to 40 mol % (i.e., 5 mol %≤Li₂O+Na₂O+K₂O≤40 mol %). In some embodiments, 0 mol %≤MgO+CaO+ZnO≤10 mol %. The glass compositions are discussed more thoroughly in U.S. Pat. No. 9,840,437, which is incorporated by reference in its entirety.

Each of the oxide components of the base and ion-exchanged composition described herein serves a function. Silica (SiO₂), for example, is the primary glass forming oxide, and forms the network backbone for the molten glass. Pure SiO₂ has a low CTE and is alkali metal-free. Due to its extremely high melting temperature, however, pure SiO₂ is incompatible with the fusion draw process. The viscosity curve is also much too high to match with any core glass in a laminate structure. In some embodiments, the glasses described herein comprise at least about 50 mol % SiO₂ and, in other embodiments, from about 50 mol % to about 80 mol % SiO₂.

In addition to silica, the glasses described herein comprise the network formers Al₂O₃ and B₂O₃ to achieve stable glass formation, low CTE, low Young's modulus, low shear modulus, and to facilitate melting and forming. Like SiO₂, Al₂O₃ contributes to the rigidity to the glass network. Alumina can exist in the glass in either fourfold or fivefold coordination. In some embodiments, the glasses described herein comprise from about 3 mol % to about 25 mol % Al₂O₃ and, in particular embodiments, from about 9 mol % to about 22 mol % mol % Al₂O₃.

Boron oxide (B₂O₃) is also a glass-forming oxide that is used to reduce viscosity and thus improves the ability to melt and form glass. B₂O₃ can exist in either threefold or fourfold coordination in the glass network. Threefold coordinated B₂O₃ is the most effective oxide for reducing the Young's modulus and shear modulus, thus improving the intrinsic damage resistance of the glass. Accordingly, the glasses described herein, in some embodiments, comprise up to about 15 mol % B₂O₃ and, in other embodiments, from about 3 mol % to about 10 mol % B₂O₃.

The alkali oxides Li₂O, Na₂O, and K₂O may be used to achieve chemical strengthening of the glass by ion exchange. Incorporation of Li₂O into the base glass composition can lead to a final ion exchanged product having both high compressive stress and anti-microbial properties. The reason for this relates to the relative ionic radii of the monovalent ions of interest: Li⁺ has a radius of 90 picometers (pm); the radius of Na⁺ is 116 pm; the radius of Ag⁺ is 129 pm; and K⁺ has a radius of 152 pm.

The glasses described herein may include Na₂O, which can be exchanged for potassium in a salt bath containing, for example, KNO₃. In some embodiments, 0 mol %≤Na₂O≤25 mol %, in other embodiments, 10 mol % to about 20 mol %. The glasses further comprise Li₂O and, optionally, K₂O. As described herein, Li⁺ cations in the glass may be exchanged for Ag⁺ cations in an ion exchange bath. The exchange of Ag+ cations for Li+ cations in the glass helps offset the reduction in compressive stress resulting from the exchange of the larger K+ cations in the glass for smaller Ag+ cations. In some embodiments, 0.1 mol %≤Li₂O≤2.5 mol %, and, in certain embodiments, 0.0 mol %≤Li₂O≤1.5 mol %. Potassium cations in the glass also undergo ion exchange with silver cations. The glass comprises up to about 5 mol %, K₂O; i.e., 0 mol %≤K₂O≤5 mol %.

Phosphorous pentoxide (P₂O₅) is a network former incorporated in these glasses. P₂O₅ adopts a quasi-tetrahedral structure in the glass network; i.e., it is coordinated with four oxygen atoms, but only three of which are connected to the rest of the network. The fourth oxygen is a terminal oxygen that is doubly bound to the phosphorous cation. Association of boron with phosphorus in the glass network can lead to a mutual stabilization of these network formers in tetrahedral configurations, as with SiO₂. Like B₂O₃, the incorporation of P₂O₅ in the glass network is highly effective at reducing Young's modulus and shear modulus. In some embodiments, the glasses described herein comprise up to about 5 mol % P₂O₅; i.e., 0 mol %≤P₂O₅≤5 mol %.

Like B₂O₃, alkaline earth oxides such as MgO and CaO, and other divalent oxides such as ZnO, also improve the melting behavior of the glass. In some embodiments, the glasses described herein comprise up to about 5 mol % MgO, up to about 10 mol % CaO, and/or up to about 10 mol % ZnO and, in some embodiments, at least about 0.1 mol % MgO, ZnO, or combinations thereof, wherein 0≤MgO≤6 mol % and 0≤ZnO≤6 mol %. In some embodiments, the glass may also comprise at least one of the alkaline earth oxides, wherein 0 mol %≤CaO+SrO+BaO≤2 mol %.

Both the base compositions and ion-exchanged antimicrobial compositions described hereinabove may further include at least one fining agent such as SnO₂, As₂O₃, Sb₂O₅, or the like. The at least one fining agent may, in some embodiments, include up to about 0.5 mol % SnO₂ (i.e., 0 mol %≤SnO₂≤0.5 mol %); up to about 0.5 mol % As₂O₃ (i.e., 0 mol %≤As₂O₃≤0.5 mol %); and up to about 0.5 mol % Sb₂O₃ (i.e., 0 mol %≤Sb₂O₃≤0.5 mol %).

Table 3 shows compositions used for the examples described herein. “G-” refers to a glass composition, while “GC” refers to a glass-ceramic composition. The numbers in the table are provided in mol %. Glass-ceramic compositions were cerammed with conditions appropriate to create transparent glass ceramic articles, unless there is a specific note that the material is a “precursor”, in which case the composition was tested as a glass (i.e., the composition can be turned into a glass-ceramic by ceramming, which is a heat-treatment that partially crystallizes the material, but it was not cerammed). There was one exception to transparency—GC4 was cerammed to a white glass ceramic.

TABLE 3
Glass-based composition information.

| Oxide (mol | | | | | |
|---|---|---|---|---|---|
| %) | G-1 | GC4 | GC1 | GC3 | GC2 |
| SiO2 | 67.4 | 69.5 | 70.7 | 69.4 | 70.4 |
| B2O3 | 3.7 | 1.8 | 0.0 | 0.0 | 0.0 |
| Al2O3 | 12.7 | 12.3 | 4.2 | 3.7 | 4.2 |
| P2O5 | 0.0 | 0.0 | 0.9 | 1.0 | 0.9 |
| Li2O | 0.0 | 7.7 | 22.1 | 21.7 | 21.4 |
| Na2O | 13.7 | 0.4 | 0.0 | 0.5 | 1.5 |
| K2O | 0.0 | 0.0 | 0.0 | 0.7 | 0.0 |
| MgO | 2.4 | 2.9 | 0.0 | 0.0 | 0.0 |
| SnO2 | 0.1 | 0.2 | 0.2 | 0.0 | 0.0 |
| ZnO | 0.0 | 1.7 | 0.0 | 0.0 | 0.0 |
| ZrO2 | 0.0 | 0.0 | 2.0 | 2.9 | 1.7 |
| TiO2 | 0.0 | 3.5 | 0.0 | 0.0 | 0.0 |

### Ion Exchange

In some embodiments, a glass-based article ion exchanged both with silver for anti-microbial properties and another material, such as K₂O, for compressive stress, is provided. The ion exchanged article comprises SiO₂, Al₂O₃, Li₂O, and Na₂O and has a compressive layer that extends from a surface of the glass to a depth of layer within the glass. The compressive layer comprises K₂O and has a maximum compressive stress of at least about 700 MPa. A first surface region 114 within the compressive layer extends from the surface of the glass to a first depth that is less than the depth of layer and comprises from about 10 mol % to about 30 mol % Ag₂O. It should be noted that ion-exchanging with silver can provide some degree of chemical strengthening, but it may be mild compared to what can be achieved with potassium due to differences in the ion sizes. But, it should be noted that antimicrobial efficacy has been demonstrated for glass-based article that are ion-exchanged only with silver, and some embodiments do not have any requirements with respect to any degree of compressive stress achieved by chemical strengthening. Glass-ceramic articles in particular can be quite durable even with lower degrees of chemical strengthening. Depending on the desired article properties, a glass-ceramic ion-exchanged with silver only may have adequate durability.

Ion exchange is widely used to chemically strengthen glasses. In one particular example, alkali cations within a source of such cations (e.g., a molten salt, or “ion exchange,” bath) are exchanged with smaller alkali cations within the glass to achieve a layer that is under a compressive stress (CS) near the surface of the glass. In the glasses described herein, for example, potassium ions from the cation source are exchanged for sodium ions within the glass during the first ion exchange step. The compressive layer extends from the surface to a depth of layer (DOL) within the glass.

The chemically strengthened ion exchanged glass described herein may be formed by first ion exchanging a base glass containing SiO₂, Al₂O₃, Li₂O, and Na₂O in first ion exchange bath comprising at least one potassium salt. Potassium ions in the ion exchange bath replace sodium ions in the base glass to the depth of layer. Because the difference in radii of potassium and sodium (152 pm vs. 119 pm) cations is much smaller compared to the difference between potassium and lithium ionic radii (152 picometers (pm) vs. 90 pm), the initial ion exchange in the potassium-containing bath yields a preferential exchange of K⁺ for Na⁺. This first ion exchange provides the high surface compressive stress favorable for strength. In some embodiments, the at least one potassium salt includes potassium nitrate (KNO₃). Other potassium salts that may be used in the ion exchange process include, but are not limited to, potassium chloride (KCl), potassium sulfate (K₂SO₄), combinations thereof, and the like. The ion exchanged glass has at least one compressive layer extending from a surface of the glass to a depth of layer within the glass.

Following the potassium-for-sodium ion exchange, the glass is ion exchanged in a second ion exchange bath containing a silver solution, where both silver-for-potassium and silver-for-lithium ion exchange take place. In one non-limiting example, Ag⁺-for-Li⁺and Ag⁺-for-K⁺ exchange is carried out in a AgNO₃-containing molten salt bath. The Ag⁺-for-Li⁺ exchange can occur much more readily due to the smaller difference in radii (129 pm vs. 90 pm) of the two cations. This leads to an increase in compressive stress that at least partially compensates for the loss in compressive stress due to Ag⁺-for-K⁺ exchange and, in some instances, there can be even a net increase in compressive stress as a result of the silver ion exchange.

The ion exchange of Ag⁺-for-Li⁺ and Ag⁺-for-K⁺ takes place in a first region within the compressive layer. As used herein, the term “compressive stress layer” refers to the layer or region under compressive stress, and the term “first region” shall be used to refer to the layer or region containing the antimicrobial silver species. This usage is for convenience only, and is not intended to provide a distinction between the terms “region” and “layer” in any way.

In another aspect, a method of making the ion exchanged, antimicrobial glasses described hereinabove is also provided. In a first step, potassium cations in a first ion exchange bath are ion exchanged for sodium cations in a base glass comprising SiO₂, Al₂O₃, Na₂O, and Li₂O. In some embodiments, the base glass is one of those described hereinabove. The ion exchange of potassium cations for sodium cations forms a compressive layer extending from a surface of the glass to a depth of layer within the glass. The compressive layer is under a first maximum compressive stress following ion exchange in the first bath.

The first ion exchange bath, in some embodiments, is a molten salt bath comprising at least one potassium salt such as, but not limited to, potassium nitrate (KNOB), potassium chloride (KCl), potassium sulfate (K₂SO₄), or the like. In some embodiments, the at least one potassium salt comprises or accounts for at least about 90 wt % of the first ion exchange bath; in other embodiments, at least about 95 wt % of the first ion exchange bath; and, in still other embodiments, at least about 98 wt % of the first ion exchange bath.

In a second step, silver cations in a second ion exchange bath are exchanged for potassium and lithium ions within the compressive layer resulting from the first ion exchange. The silver cations provide the glass with antimicrobial activity. The second ion exchange bath, in some embodiments, is a molten salt bath comprising at least one silver salt such as, but not limited to, silver nitrate (AgNO₃), silver chloride (AgCl), silver sulfate (Ag₂SO₄), or the like. In some embodiments, the at least one silver salt comprises at least about 5 wt % of the second ion exchange bath; in other embodiments, at least about 10 wt % of the second ion exchange bath; and, in still other embodiments, at least about 20 wt % of the second ion exchange bath.

After ion exchanging silver cations for potassium and lithium cations, the compressive layer has a second maximum compressive stress which, in some embodiments, is at least 80% of the first maximum compressive stress and, in other embodiments, at least 90% of the first maximum compressive stress. In some embodiments, the second maximum compressive stress is greater than or equal to the first maximum compressive stress. In certain embodiments, the second maximum compressive stress is at least about 700 MPa, in other embodiments, at least 750 MPa, in other embodiments, at least 800 MPa, and, in still other embodiments, at least about 850 MPa.

### Manufacturing Process

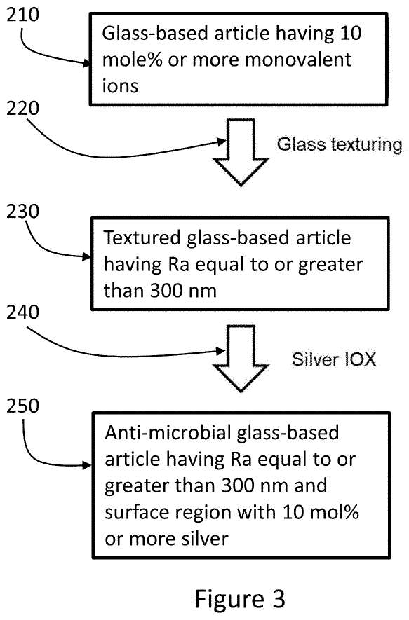

FIG. 3 is a flowchart illustrating a process for making glass-based articles descried herein. The process starts with a glass-based article 210 having a suitable base composition. The base composition includes 10 mol % or more monovalent metal ions that may be replaced using ion exchange with silver. In step 220, the article is textured by laser, sandblasting, and/or chemical process, resulting in a textured or roughened glass-based article having a surface roughness Rₐ of 300 nm or more. The chemical process may include exposure to HF or NaOH. The textured glass is treated in silver ion containing molten salt bath in step 240 to install silver ions in the surface region, resulting in anti-microbial glass-based article 250 to glass surface layer.

### EXPERIMENTAL

### Example 1. Samples 1 and 2

Material: 0.8 mm*50 mm*50 mm GC1

Laser treatment conditions: In this case, surface features(micro-craters) were textured on a piece of glass ceramic substrate using an ultrafast laser system (Pharos, Light Conversion). The central wavelength, pulse width, and repetition rate of the diode pumped solid state laser were set at 1030 nm, 300 fs, and 200 kHz, respectively. The output power (maximum) of the laser was 4 W and the actual power used for fabrication was approximately 10 μJ per pulse for #1 (˜6 μJ per pulse for S6). The laser beam was steered through a galvanometer scanner and focused on glass ceramic samples through a conventional F-theta lens with the focal length of 80 mm. The spot size was ˜17 μm in air at the focal point. The glass ceramic sample was rapidly scanned via cross-hatching method with a pitch of 25 μm. The scanning speed of the scanner was set at 500 mm/s. Laser fluences can be tuned by adjusting either the internal laser attenuators or the external modulations (i.e., RTC 4/5 board).

Etch conditions: the laser textured glass was etched in 50 wt % NaOH at 132° C. for 3 hr. The etching process removes 7.5 um per side of glass surface.

IOX conditions: The textured glass is treated in molten salt bath containing 47.5 wt % KNO₃, 47.5 wt % NaNO₃, and 5 wt % AgNO₃ at 390° C. for 1 hr.

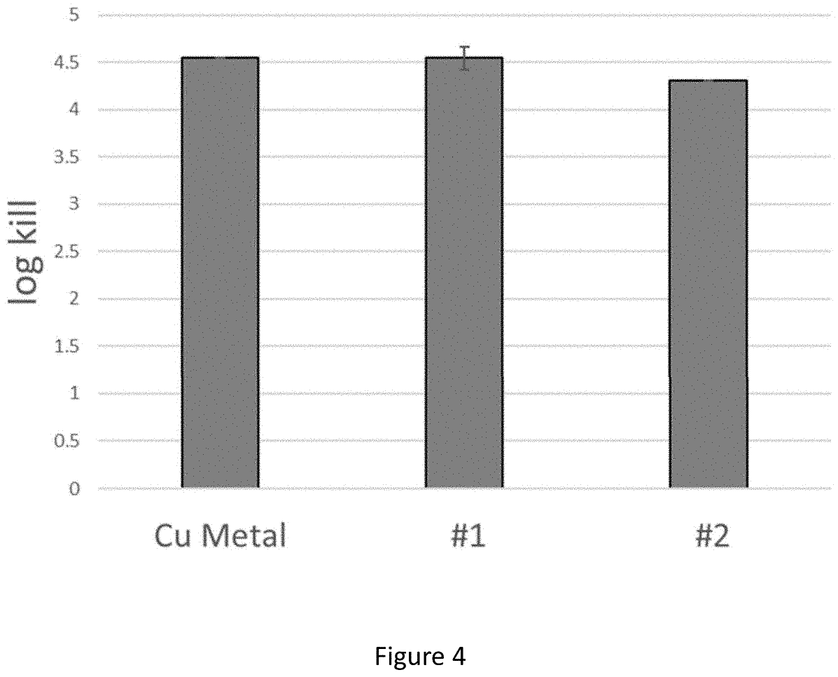

The treated glasses are evaluated by EPA Dry Test using Staph. Results are shown in FIG. 4. The laser textured GC1 shows high AM efficacy that passes the EPA Dry Test with over 3 log kill.

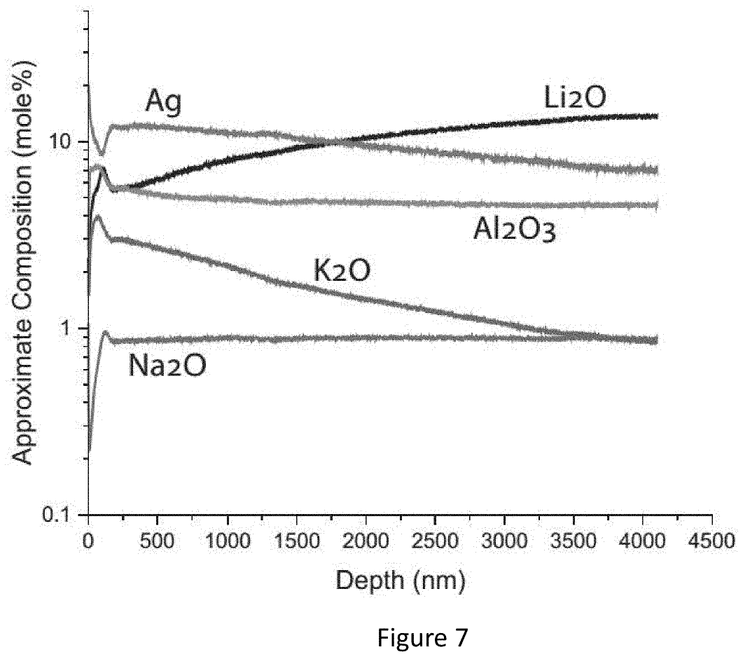

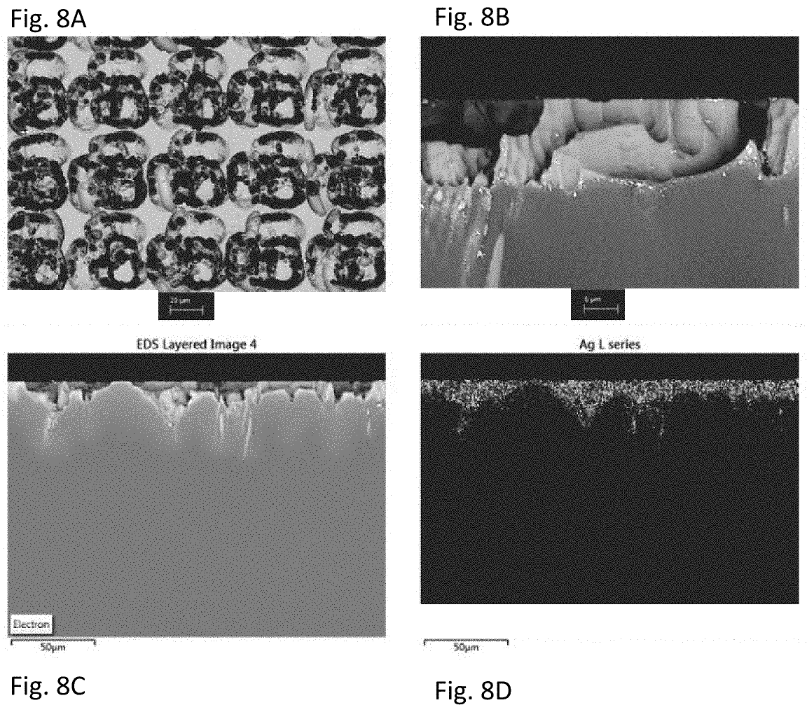

The surface of Sample 1 was characterized by SEM/ED. See FIG. 8A through 8C. The images show that the surface is very rough and contains high concentration of silver ions, see FIG. 8D. SIMS analysis shows that Ag concentration is over 10 mol % average across the first micron of depth, i.e., in surface region 114. See FIG. 7, which shows the results of SIMS analysis for Sample 1.

FIG. 4 shows log kill rates according to the EPA Dry Test for Samples 1 and 2 (GC1) according to Example 1. Both glasses exhibit superior AM efficacy in the EPA dry test. Surprisingly, the efficacy is similar to that of a sheet of Cu metal under dry test conditions.

### Example 2. Comparison of Textured and Non-Textured GC1

Material: 0.8 mm*50 mm*50 mm GC1

Pre-silver IOX sample information: Samples 8 and 9 were textured using the same conditions as example 1. Sample 10 was laser textured with different conditions to result in less roughness as described below. After laser treatment, Samples 8, 9 and 10 were etched in 50 wt % NaOH at 132° C. for 3 hr to remove 7.5 um surface layer per side.

For the laser treatment of Sample 10, single pulse modifications were textured on a piece of glass ceramic substrate using an ultrafast laser system (Pharos, Light Conversion). The central wavelength, pulse width, and repetition rate of the diode pumped solid state laser were set at 1030 nm, 300 fs, and 100 kHz, respectively. The output power (maximum) of the laser was 6 W and the actual power used for fabrication was approximately 60 μJ per pulse. The laser beam was steered through a galvanometer scanner and focused on glass ceramic samples through a conventional F-theta lens with the focal length of 80 mm. The spot size was ˜17 μm in air at the focal point. The glass ceramic sample was rapidly scanned via bidirectional hatching method with a pitch of 25 μm. The scanning speed of the scanner was set at 500 mm/s. Additionally, pulse picker was set at appropriate value (i.e., 10) to match the pitch between two adjacent pulses along laser scanning direction. Laser fluences can be tuned by adjusting either the internal laser attenuators or the external modulations (i.e., RTC 4/5 board).

Sample 3 is plain GC1 without any IOX except the silver IOX.

Samples 4 and 5: prior to silver IOX, Samples 4 and 5 were IOX'ed in molten salt bath containing 60% KNO₃, 40 wt % NaNO₃, additional 0.5wt % silicic acid, at 500° C. for 8 hr.

Samples 6 and 7: prior to silver IOX, Samples 4 and 5 were IOX'ed in molten salt bath containing 60% KNO₃, 40wt % NaNO₃, additional 0.5 wt % silicic acid, additional 0.12% LiNO₃ at 500° C. for 8 hr.

Each of Samples 3 through 10 were cleaned by DI water before silver IOX.

Silver IOX condition: Each of Samples 4 through 7 were treated in molten salt bath containing 47.5 wt % KNO₃, 47.5 wt % NaNO₃, and 5 wt % AgNO₃, and additional 0.12 wt % LiNO₃ at 390° C. for 10 min. Each of Samples 3, 8-10 are treated the same as Samples 4-7, but without the additional 0.12 wt % LiNO₃. It is believed that performing silver IOX without LiNO₃ leads to a surface effect where more silver may be present at or near the surface, but at the cost of some chemical durability.

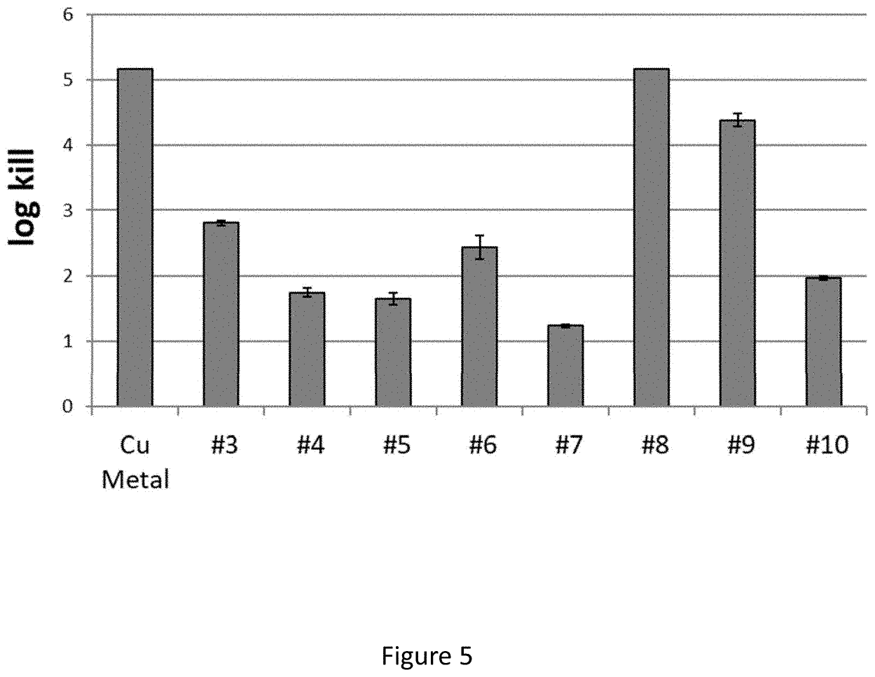

Samples 3 through 10 were evaluated for anti-microbial efficacy using the EPA Dry Test using Staph. Results are shown in FIG. 5. Samples 8 and 9, with high roughness surface achieved by laser texturing and etch, passed the EPA AM dry test with over 3 log kill. Other samples show kill rates lower than 3 log kill.

FIG. 5 shows log kill rates according to the EPA Dry Test for Samples 3 through 10 (GC1, various textures). The roughest samples, which were lasered treated then etched, exhibit superior AM efficacy in the EPA dry test, equivalent to the AM performance of Cu metal). The other, less rough samples show lower AM efficacy in the range 1 to 3 log kill.

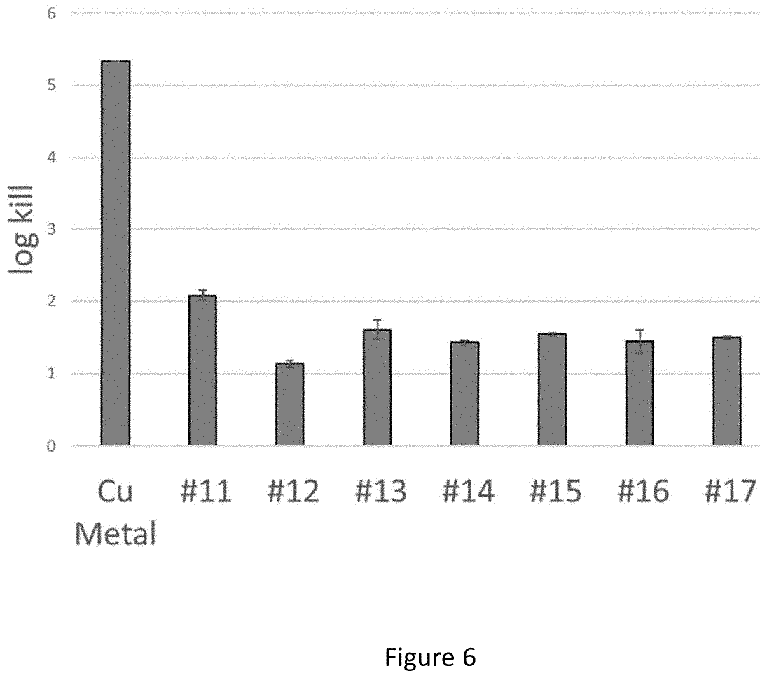

It should be noted that FIG. 5 (and FIG. 4, FIG. 6) uses a log scale, which is designed to show large differences in a compact graph. A distance of 1 on the y-axis represents a 10-fold increase or decrease, a distance of 2 represents a 100-fold increase or decrease, and so on. So, for example, going from 2.5 to 5 on the y axis (roughly Sample 6 to Sample 8) means that the sample at log 5 has less surviving bacteria than the sample at log 2.5 by a factor of over 300. In other words, the sample at log 5 is far better than twice as good as the sample at log 2.5, even though 5 is twice 2.5.

### Example 3. Compare Different Glass and Glass-Ceramic Materials (FIG. 7)

Different glass-based materials were chosen for Example 3. Base compositions are listed in Table 3. Processing details are listed in Table 1.

Sample 11 was laser textured using the same conditions as described in Example 1. Samples 12-17 were tested as received, without roughening.

Each of Samples 11 through 17 were IOX'ed in molten salt bath containing 47.5 wt % KNO₃, 47.5 wt % NaNO₃, and 5 wt % AgNO₃ at 350° C. for 10 min.

AM test: Each of Samples 11 through 17 was evaluated by the EPA Dry Test using Staph. See FIG. 6.

FIG. 6 shows log kill rates according to the EPA Dry Test for Samples 11 through 17 (various materials). After silver IOX, the laser textured glass (Sample 11) shows significant higher AM efficacy than the non-textured counterpart (Sample 12). Sample 11 demonstrates an antimicrobial efficacy approaching 3 log kill under the EPA Dry Test for a glass material, which is quite exceptional. It should be noted that most of the samples of FIG. 6 were not laser textured. It is expected that there would be significant improvement in AM efficacy from the increased roughness accompanying laser texturing.

### Example 4—SIMS Evaluation of Sample 1

Samples 18-20 were fabricated using conditions similar to, but not exactly the same, as Samples 2, 7 and 3, respectively.

Sample 18 was similar to Sample 2, with the following differences: Sample 18 had different Ag IOX conditions from Sample 2. Specifically, the conditions for Sample 10 were: 47.5 wt % KNO₃, 47.5 wt % NaNO₃, and 5 wt % AgNO₃ at 350° C. for 10 min. Sample 18 was tested for silver ion release rate, whereas Sample 2 was not. Because Sample 2 had more aggressive silver IOX conditions, the testing on Sample 18 shows that Sample 2 had a silver ion release rate in excess of the 37000 ppb/2.25 in² into a neutral pH salt solution at 60° C. over 2 hours exhibited by Sample 18.

Sample 19 was similar to Sample 7, with the following differences: Sample 19 had different Ag IOX conditions from Sample 7. Specifically, the conditions for Sample 19 were: 47.5 wt % KNO₃, 47.5 wt % NaNO₃, and 5 wt % AgNO₃ at 350° C. for 10 min. Sample 19 was tested for silver ion release rate, and exhibited a release rate of 4270 ppb/2.25 in².

Sample 20 was similar to Sample 3, with the following differences: Sample 20 had different Ag IOX conditions from Sample 7. Specifically, the conditions for Sample 20 were: 47.5 wt % KNO₃, 47.5 wt % NaNO₃, and 5 wt % AgNO₃ at 350° C. for 10 min. Sample 20 was tested for silver ion release rate, and exhibited a release rate of 15560 ppb/2.25 in².

### Example 5—SIMS Evaluation of Sample 1

Sample 1 was evaluated by SIMS to determine a composition profile vs depth. FIG. 7 shows the result of that evaluation. FIG. 7 shows that Sample 1 has a silver ion concentration higher than 10 mol % across the first micron (1000 nm) of depth. FIG. 7 also shows increasing Li content with depth, showing that the Ag exchanged primarily with Li during ion exchange. It is expected that other materials with similar Li content, after exposure to similar Ag ion exchange, will Ag SIMS profiles similar to that of Sample 1. For example, it is expected that other samples made with GC1, as well as samples made with GC2 and GC3, will have similar Ag content.

### Example 6—SEM/EDS Analysis of Sample 1

A SEM/EDS (scanning electron microscope/energy dispersive X-ray spectroscopy) analysis was performed for the surface of Sample 1. FIGS. 8A through 8D show the results of this analysis. FIG. 8A shows a top view of the textured GC1 surface with Backscatter electron mode (scale bar: 20 um). FIG. 8B shows a cross-sectional view of the textured surface (Scale 5: 5 um). FIG. 8C shows a cross-section view of the textured surface at a different scale (Scale bar: 50 um). FIG. 8D shows a cross-section view with highlighted silver distribution mapped by EDS.

FIG. 9 shows a correlation of EPA dry test Log kill and released silver concentration from the silver ion release rate.

### Example 7—EPA Dry Test

Samples were evaluated for anti-microbial efficacy using a test method published by the EPA as “Test Method for Efficacy of Copper Alloy Surfaces as a Sanitizer”. Details are provided here as well, with steps numbered according to the EPA protocol:
1. Stock cultures: Initiate new stock cultures from lyophilized cultures from ATCC at least once every 18 months. Open ampule of freeze-dried organism per manufacturer's instructions
2. Using a tube containing 5-6 mL of tryptic soy broth (TSB), aseptically withdraw 0.5 to 1.0 mL and rehydrate the lyophilized culture. Aseptically transfer the entire rehydrated pellet back into the original tube of broth. Mix thoroughly. Incubate broth culture at 36±1° C. for 24±2 hours
3. After incubation, streak a loopful of the suspension on tryptic soy agar (TSA) to obtain isolated colonies. Incubate the plates for 18-24 hat 36±1° C.
4. Select 3-5 isolated colonies of the test organism and re-suspend in 1 mL of TSB. For S. aureus, select only golden yellow colonies. Spread plate 0.1 mL of the suspension on each of the 6-10 TSA plates. Incubate the plates for 18-24 h at 36±1° C.
5. Following the incubation of the agar plates, place approximately 5 mL sterile cryoprotectant solution on the surface of each plate. Re-suspend the growth in the cryoprotectant solution using a sterile spreader without damaging the agar surface. Aspirate the suspension from the plate with a pipette and place it in a sterile vessel large enough to hold about 30 mL. Repeat the growth harvesting procedure with the remaining plates and continue adding the suspension to the vessel (more than 1 tube may be used is necessary). Mix the contents of the vessel(s) thoroughly; if more than 1 vessel is used, pool the vessels prior to aliquoting culture. Immediately after mixing, dispense 0.5-1 mL aliquots of the harvested suspension into cryovials; these represent the frozen stock cultures
6. Store the cryovials at −70±5° C. for a maximum 18 months then reinitiate with a new lyophilized culture

Conduct Quality Control check of the pooled culture concurrently with freezing. For example, streak a loopful on a blood agar plate, and selective media such as mannitol salt agar (MSA) and Cetrimide. Incubate all plates at 36±1° C. for 24±2 hours. Record the colony morphology as observed on the blood agar plates and selective media plates (including the absence of growth). Perform a Gram stain from growth taken from the blood agar plates and observe the Gram reaction by using bright field microscopy at 1000× magnification (oil immersion)

### Test Cultures

8. For S. aureus, defrost a single stock culture cryovial at room temperature and briefly vortex to mix. Each cryovial should be single use only. Add 20 uL of the thawed stock to a tube containing 10 mL of TSB and then vortex to mix. Incubate at 36±1° C. for 18-24 hours. Following incubation, use the broth culture to prepare a final test suspension. Briefly vortex the culture prior to use
9. Dilute in Phosphate Buffered Saline (PBS) or concentrate the culture appropriately to achieve the target carrier counts (4-5 logs/carrier). Centrifuge the 18-24 h broth cultures to achieve the desired level of viable cells on the dried carrier. Centrifuge at ˜5000 gN for 20±5 min and re-suspend the pellet in 6 mL 1× PBS. Note: Remove the supernatant without disrupting the pellet. For S. aureus, disrupt the pellet using vortexing or repetitive tapping/striking against a hard surface to disaggregate the pellet completely prior to re-suspending it in 6 mL. If necessary, add 1 mL of PBS to the pellet to aid in disaggregation
10. Purity of the final test culture (with soil load) should be determined by streak isolation on TSA with 5% sheep's blood, or other appropriate plating medium, incubate (36±° C. for 48±4 hr), examine for purity
11. Titer of the final test culture (with soil load) will be determined for informational purposes. Plate dilutions on TSA plates or other appropriate medium and incubate (36±1° C. for 24-48 hr) and enumerate. Count the number of colonies to determine the number of organisms per mL (i.e. CFU/mL) of the inoculum present at the start of the test

### Soil Load

12. Add 0.25 ml aliquot of fetal bovine serum +0.05 ml Triton X-100 to 4.70 ml bacteria suspension to yield a 5% fetal bovine serum and 0.01% Triton X-100 soil load. Following the addition of soil load, vortex the final test suspension for 10 seconds and immediately prior to use

### Efficacy Test Procedure

13. Evaluate treated test carriers with untreated control carriers against the test organism
14. Coated control carriers should be evaluated concurrently with the coated test carriers
15. The exposure (contact time) of the inoculum to the carrier surface begins immediately upon inoculation; therefore, the contact time begins when final test suspension (with soil load) is deposited onto a carrier
16. Record the initiation of the contact time and inoculate each carrier at staggered intervals with 20 μL of final test culture using a calibrated pipette (a positive displacement pipette is desirable)
17. Spread the inoculum across the surface of the carrier moving back and forth to ensure full coverage of the surface, spreading as close to the edge of carrier as possible using a bent pipette tip. Use an appropriate interval (e.g. 30 sec to allow enough time for careful spreading of the inoculum)
18. The contact time begins immediately following carrier inoculation. Record the lab temperature and relative humidity during the two-hour exposure period
19. Allow carriers to remain in a horizontal position under ambient conditions on the Petri plate for 120±5 min
20. Following the exposure period, sequentially and aseptically transfer carriers to 20 mL of Letheen broth (neutralizer solution)—this represents the 10° dilution
   a. For samples larger than 1″×1″, a plastic sticker (prepared using the Silhouette cutter system) with a 1″×1″ opening is add to the surface to achieve the correct testing area. These are added to Whirl Pak bags with the 20 mL neutralizer for sonication (next step).
21. After all the carriers have been transferred into the neutralizer, sonicate for 5 min±30 secs to suspend any survivors from the carriers, swirl to mix.
22. Within 30 mins of sonication, prepare serial dilutions of the neutralized solution (10° dilution) out to 10⁻³ for the treated carriers. Transfer the coated control carriers to neutralizing subculture medium and plate the appropriate dilutions in duplicate to yield countable numbers (up to 300 colonies per plate). Incubate and enumerate with the treated carrier plates
23. Plate 1.0 mL aliquots of 10° dilution and 0.10 mL aliquots of the 10° -10-3 dilutions in duplicate using standard spread plating technique on TSA plates
24. Incubate the plates at 36±1° C. for 48±4 hr
25. Following incubation, count colonies and record results
26. Alternate incubation conditions may be needed for certain organisms. The incubation conditions may be modified to suit the test organisms if needed. If necessary, subculture plates can be stored for up to 3 days at 2-8° C. prior to enumeration

### Example 8—Silver Ion Release Rate Test

### Sample Prep (samples are 50 mm×50 mm)

1. Samples are tested in triplicate (unless otherwise stated).
   a. Hydrophilic: A sticky square with a 1.5″×1.5″ opening is placed carefully onto the coupon and sealed avoiding bubbles and creases.
   b. Hydrophobic: no sticky squares, 24×30 mm Thermanox plastic coverslips spread solution over specified surface area.

### Solution Prep & Sample “Inoculation” (Sodium Nitrate)

2. Prepare a 10× NaNO₃ solution (100 mM) by dissolving 4.2495 g sodium nitrate in distilled water and bring the final volume to 500 mL. From the 10× prepare a 1× (10 mM) solution: 10 mL 10× in 90 mL distilled water.
3. On the Hydrophilic samples add 750uL of the 1X solution to the coupon within the sticky square. Add a 1.5″×1.5″ PE film on top of the solution to spread it over the surface within the sticky square. Avoid air bubbles.
4. On the Hydrophobic samples add 375 uL of the 1× solution onto the coupon and cover with the Thermanox coverslip again avoiding air bubbles. Repeat this step for a second spot on the same coupon. DO NOT LET THESE TWO SPOTS MEET, maintain a gap!
5. Place the samples in the incubator for 2 hrs at 60 C, 85% relative humidity.

### Sample Collection

6. Hydrophilic Samples: carefully lift the PE film off the sample with the needle point forceps preventing leaking off the surface that was tested. Carefully collect 500 uL of the solution and put into a corresponding 15 mL conical tube.
7. Hydrophobic Samples: carefully lift one Thermanox coverslip off and dispose, lift the second coverslip and use this to pool the two spots together to make one large collection. Collect 500 uL of the solution and place into a 15 mL conical tube.

### CONCLUSION

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. An antimicrobial glass-based article, comprising:
a first major surface opposing a second major surface;
a first surface region extending 1 micron into the article from the first major surface having:
an average Ag₂O concentration across the first surface region of equal to or greater than 10 mol % and equal to or less than 30 mol %; and
a surface roughness Rₐ of 100 nm or greater.

2. The article of claim 1, wherein the first major surface has a surface roughness Rₐ 300 nm or greater.

3. The article of claim 1, wherein the article exhibits a silver ion release rate of equal to or greater than 10,000 ppb/2.25 in² into a neutral pH salt solution at 60° C. over 2 hours.

4. The article of claim 1, wherein the article exhibits a silver ion release rate of equal to or greater than 10,000 ppb/2.25 in² and equal to or less than 30,000 ppb/2.25 in².

5. The article of claim 1, wherein the article exhibits a log kill equal to or greater than 3 according to the EPA Dry Test with Staph aureus bacteria.

6. The article of claim 1, wherein the article exhibits a log kill equal to or greater than 4 according to the EPA Dry Test with Staph aureus bacteria.

7. The article of claim 1, wherein the article exhibits a transmittance equal to or greater than 85%.

8. The article of claim 1, wherein the article has a color delta E equal to or less than 10 when compared to an otherwise equivalent article without Ag₂O.

9. The article of claim 8, wherein the article has a color delta E equal to or less than 7 when compared to an otherwise equivalent article without Ag₂O.

10. The article of claim 1, wherein the article has a thickness of 0.2 mm to 3 mm.

11. The article of claim 1, wherein the article is chemically strengthened with an ion in addition to silver.

12. The article of claim 1, wherein the glass-based article has a base composition comprising: from about 50 mol % to about 80 mol % SiO₂; from about 3 mol % to about 25 mol % Al₂O₃; up to about 15 mol % B₂O₃; from about 0 mol % to about 25 mol % Na2O; up to about 5 mol % K₂O; up to about 35 mol % Li₂O; up to about 5 mol % P₂O₅; up to about 5 mol % MgO; up to about 10 mol % CaO; and up to about 10 mol % ZnO; and wherein 10 mol %≤Li₂O+Na₂O+K₂O≤40 mol %.

13. A process of making a roughened antimicrobial glass-based article having a first major surface opposing a second major surface, comprising:
roughening a glass-based article to create a roughened glass-based article;
exposing the roughened glass-based article to an ion-exchange bath that exchanges silver ions into the roughened glass-based article, to create the roughened antimicrobial glass-based article, wherein the first surface of the roughened antimicrobial glass-based article has:
a first surface region extending 1 micron into the article from the first major surface having: an average Ag₂O concentration across the first surface region of equal to or greater than 10 mol % and equal to or less than 30 mol %; and a surface roughness Rₐ of 100 nm or greater.

14. The process of claim 13, wherein the glass-based article is roughened by:
exposing the first surface to a laser; then
etching the first surface with an etchant.
